(19) United States
(12) Patent Application Publication
(10) Pub. No.: US 2016/0220855 A1
(43) Pub. Date: Aug. 4, 2016

(54) Tactical Harness with Shoulder Controlled Braking Mechanism

(71) Applicant: Norman E. Wood, Cameron, WV (US)

(72) Inventor: Norman E. Wood, Cameron, WV (US)

(21) Appl. No.: 14/841,789

(22) Filed: Sep. 1, 2015

Related U.S. Application Data
(63) Continuation of application No. 14/612,105, filed on Feb. 2, 2015, now abandoned.

(51) Int. Cl. A62B 35/00

(52) U.S. Cl. CPC A62B 35/0018; A62B 35/0037; A62B 35/0081

(57) ABSTRACT

A tactical descent system harness adapted for wearing to rapidly descend from a height of twenty to several hundred feet by moving a wearer's shoulders forward to slow or completely stop descent and by moving the wearer's shoulders backward to allow for a faster controlled descent. The harness includes a rack having a plurality of apertures through which an elongated section of line is threaded and then stored in a bag for positioning on a lower rear section of the harness. In addition, the harness includes a braking strap located on a rear of the harness, attached at both ends with a strap of webbing that passes under each of the wearer's arm and to each front upper shoulder strap.

### CROSS-REFERENCE TO RELATED APPLICATIONS

This is a continuation of application Ser. No. 14,612,105, filed on Feb. 2, 2015, which was a perfection of Provisional Application No. 61/934,741, filed on Feb. 1, 2014, the disclosures of which are fully incorporated by reference herein.

### FIELD OF THE INVENTION

This invention relates to controlled descent harnesses. More particularly, it relates to tactical harnesses for use by military and/or police personnel.

### SUMMARY OF THE PHOTOS

Further features, objectives and advantages will be made clearer with the following detailed description made with reference to the accompanying photographs in which:

FIG. 1 is a front view showing one embodiment of this harness installed on a mannequin;

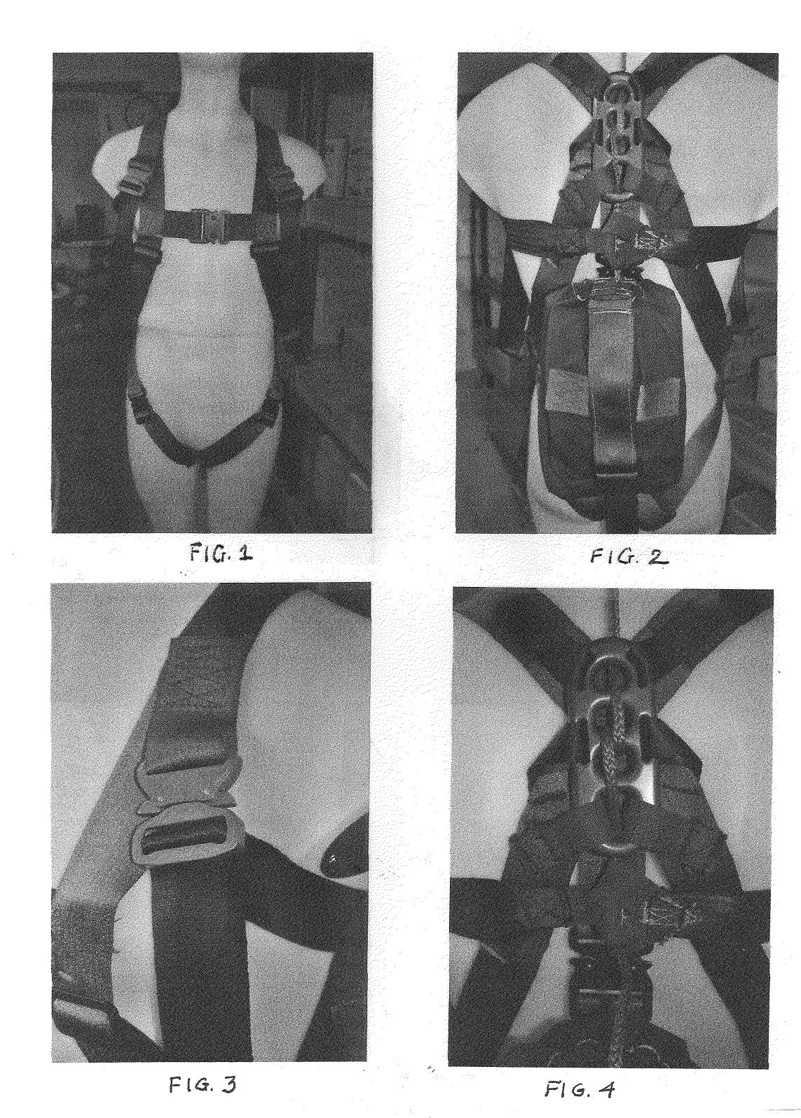

FIG. 2 is a rear view of the harness from FIG. 1 installed on the mannequin; enlarged view of the full harness front;

FIG. 3 is an enlarged view of one quick release buckle for use with the present invention;

FIG. 4 is an enlarged view of one embodiment of line feeding into an EDS Rack according to the invention;

FIG. 5 is an enlarged rear view focusing on the lower assembly and line bag therefor; and

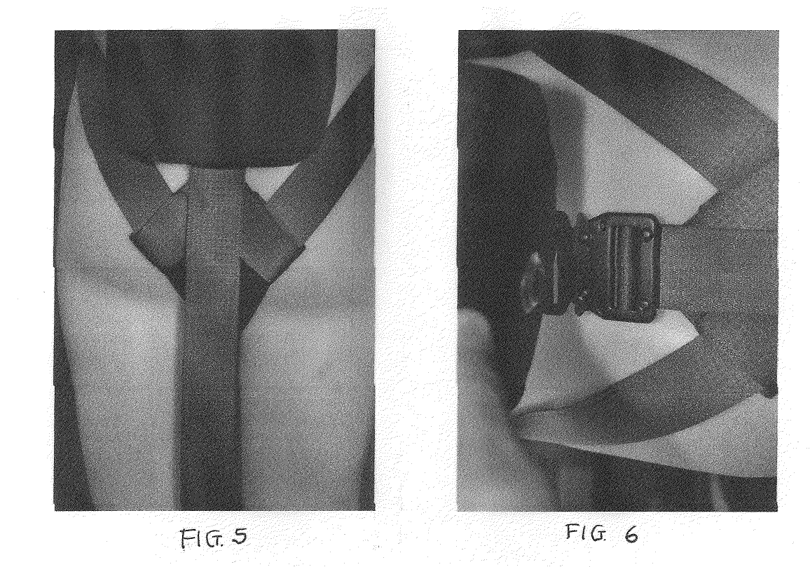

FIG. 6 is an enlarged view showing a quick release buckle beneath the line bag.

### Detailed Description of Preferred Embodiments

Full body harness designed for Tactical Military, Police or other descending requirements. Harness allows the user/operator to rapidly descend from 20 to several hundred feet. And with a more controlled rate of descent, the user is better able to free-spool and land safely, like jumping from only 6-8 feet. Unlike with current repelling techniques and equipment that require a user to hold onto a large diameter line to control descent speed, with the Fox 1™ Tactical Harness both hands are free to deploy a weapon and defend the user all the way to the ground. The user does not have to use his hands to control descent. All line storage, brake and friction device are located on the rear of the harness and out of the way of the user so as to not obstruct his/her vision and/or interfere with weapon use.

Braking is accomplished using shoulder movements alone—truly hands free. By moving the shoulders forward, braking increases and a slower descent or coming to a complete stop is accomplished. By moving the shoulders backward, less pressure is applied to the brake and a faster descent is allowed.

The Kevlar® Delta Cross Brake is used to apply 360 degree pressure over a 3 inch area to the small diameter line. When pressure is applied to the Kevlar® Delta Cross Brake, the line not only has pressure applied in a 360 degree area but it is pulled in two directions at the same time and bent, increasing the frictional force on the line.

The line has additional friction applied as it transitions through the EDS Rack (Emergency Descent System). The configuration of that line going through the rack (See FIG. 4) and the device as a whole can be changed to increase or decrease drag depending on the weight of the user and his/her equipment thus making it more adjustable to the individual user.

In combination of the Kevlar® Delta Cross Brake and the EDS Rack, a very small diameter line, ⅛ or 3/16 inch can be used. This allows for 200 feet or more of the small diameter line to be stored, and deployed, in a very small 6×8 inch Line Bag that is positioned on the lower back side of the Fox 1™ Tactical Harness. The Kevlar® Delta Cross Brake located on the rear of the harness is attached on both ends with a web strap that goes under each arm and to the front upper shoulder on each side. Both Brake Webbing Straps are adjustable for tension.

The Line Bag (FIG. 5) is attached to the harness by a Lower Y Strap and Buckle and by an Upper Buckle. This allows for the Line Bag to be removed quickly and a new line of the same or different lengths can be attached. The Line is laid in the Line Bag in a zigzag pattern layer after layer to allow for increased storage capacity and to ensure a tangle free transition up out of the bag, through the Kevlar® Delta Cross Brake, up through the EDS Rack and to its fixed attachment point.

Quick Release Buckles (See FIG. 3) are used on the legs, chest and shoulders, this allows the user to be able to shed the Fox 1 Tactical Harness in less than 5 seconds. The harness is very light and can be very easily and quickly put on. Adjustments on the shoulders, chest and legs straps allow for various size users.

The Line used is a Technora® line, that is cut, melt and burn resistant and has a very high tensile strength 3000 to 5600 pound. The line is also very light weighing approximately 1 pound per every 100 feet, and is very compactable. A typical unit uses 200 feet of line (weighing 2 lbs) though lengths of up to 1000 feet are feasible.

What is claimed is:

1. A tactical descent system harness adapted for wearing to rapidly descend from a height of twenty to several hundred feet and control a wearer's rate of descent hands free, said tactical harness including:
an adjustable belt that extends around a wearer's upper chest;
a pair of adjustable straps for wrapping about the wearer's upper thighs;
a pair of shoulder straps extending to said upper thigh straps, over the wearer's shoulders and criss-crossing on the wearer's back;
a rack having a plurality of apertures through which an elongated section of line is threaded and then stored in a bag for positioning on a lower rear section of the harness, said rack being connected to the criss-crossing shoulder straps on the wearer's back; and
a braking strap located on a rear of the harness, attached at both ends with a strap of webbing that passes under each of the wearer's arm and to each front upper shoulder strap.

2. The tactical harness of claim 1 wherein the braking strap allows the wearer to control descent by moving the wearer's shoulders forward to apply more pressure on the line and slow or completely stop descent and by moving the wearer's shoulders backward applying less line pressure to allow for a faster controlled descent.

3. The tactical harness of claim 1 wherein the braking strap is configured to apply 360 degree pressure over a small section of the line.

4. The tactical harness of claim 3 wherein the small section of the line to which the braking strap applies pressure is less than 5 inches long.

5. The tactical harness of claim 4 wherein the small section of the line to which the braking strap applies pressure is about 2.5 to 4 inches long.

6. The tactical harness of claim 1 wherein the braking strap is also pulled in two directions at the same time and bent for increasing frictional force on the line.

7. The tactical harness of claim 1 wherein configuration of the line threading through the rack can be changed for increasing or decreasing drag on the line depending on the wearer's weight.

8. The tactical harness of claim 1 wherein the bag in which the line is stored can be quickly removed from the lower rear section of the harness and replaced by a bag containing a similar or different quantity of the line.

9. The tactical harness of claim 1 wherein the line has a small diameter of less than ¼″, is burn resistant and has a tensile strength of up to 5600 pounds.

10. The tactical harness of claim 9 wherein the line has a diameter from ⅛″ to 3/16″.

11. The tactical harness of claim 9 wherein the line is made from Technora®.

12. The tactical harness of claim 9 wherein the line within the bag is stored in a zigzag pattern, layer after layer, for increased storage capacity and for tangle-free removal therefrom when the wearer descends.

13. The tactical harness of claim 1, which further includes a plurality of quick release buckles for the wearer to be able to extract fully from the harness in a short amount of time.

14. The tactical harness of claim 13 wherein said quick release buckles allow the wearer to be able to extract fully from the harness in less than 5 seconds.

15. A tactical descent system harness adapted for wearing to rapidly descend from a height of twenty to several hundred feet by moving a wearer's shoulders forward to slow or completely stop descent and by moving the wearer's shoulders backward to allow for a faster controlled descent, said tactical harness including:
an adjustable belt that extends around a wearer's upper chest;
a pair of adjustable straps for wrapping about the wearer's upper thighs;
a pair of shoulder straps extending to said upper thigh straps, over the wearer's shoulders and criss-crossing on the wearer's back;
a rack having a plurality of apertures through which an elongated section of line is threaded and then stored in a bag for positioning on a lower rear section of the harness, said rack being connected to the criss-crossing shoulder straps on the wearer's back and configuration of the line threading through the rack can be changed for increasing or decreasing drag on the line depending on the wearer's weight; and
a braking strap located on a rear of the harness, attached at both ends with a strap of webbing that passes under each of the wearer's arm and to each front upper shoulder strap.

16. The tactical harness of claim 15 wherein the braking strap is configured to apply 360 degree pressure over a small section of the line less than 5 inches long.

17. The tactical harness of claim 15 wherein the braking strap is also pulled in two directions at the same time and bent for increasing frictional force on the line.

18. The tactical harness of claim 15 wherein the bag in which the line is stored can be quickly removed from the lower rear section of the harness and replaced by a bag containing a similar or different quantity of the line.

19. The tactical harness of claim 15 wherein the line is made from Technora®, has a small diameter from ⅛″ to 3/16″, is burn resistant and has a tensile strength of up to 5600 pounds.

20. The tactical harness of claim 15 wherein the line within the bag is stored in a zigzag pattern, layer after layer, for increased storage capacity and for tangle-free removal therefrom when the wearer descends.
